(19) United States
(12) Patent Application Publication
(10) Pub. No.: US 2026/0031324 A1
(43) Pub. Date: Jan. 29, 2026

(54) METHODS OF INCREASING BATTERY CYCLE LIFE

(71) Applicant: Toyota Research Institute, Inc., Los Altos, CA (US)

(72) Inventors: William C. Chueh, Menlo Park, CA (US); Shijing Sun, Seattle, WA (US); Xiao Cui, Mountain View, CA (US); Sunny Wang, Menlo Park, CA (US); Stephen Dongmin Kang, Seoul (KR); Justin Rose, Pleasanton, CA (US); Huada Lian, Palo Alto, CA (US); Alexis Geslin, Palo Alto, CA (US); Stephen Bartholomew Joseph Torrisi, San Francisco, CA (US); Martin Z. Bazant, Wellesley, MA (US)

(73) Assignees: Toyota Research Institute, Inc., Los Altos, CA (US); Toyota Jidosha Kabushiki Kaisha, Toyota-shi Aichi-ken (JP); The Board of Trustees of the Leland Stanford Junior University, Stanford, CA (US); Massachusetts Institute of Technology, Cambridge, MA (US)

(21) Appl. No.: 19/279,162

(22) Filed: Jul. 24, 2025

Related U.S. Application Data
(60) Provisional application No. 63/675,017, filed on Jul. 24, 2024.

(51) Int. Cl. H01M 4/04; H01M 10/0525

(52) U.S. Cl. CPC H01M 4/0445; H01M 10/0525

(57) ABSTRACT

A method for extending battery cycle life of Li-ion battery includes executing a fast formation protocol on a Li-ion battery cell (cell) such that an induced Li loss shifts an electrode-specific utilization range with a lithiation level of the positive electrode decreased to be less than or equal 94% as determined via differential voltage analysis. Also, the fast formation protocol of the cell includes charging the cell to a maximum charging voltage of the cell in less than 2 hours during a first formation cycle and avoiding a kinetically limited region of the positive electrode.

### CROSS-REFERENCE TO RELATED APPLICATIONS

This application claims the benefit of U.S. Provisional Application No. 63/675,017, filed Jul. 24, 2024, which is incorporated herein in its entirety by reference.

### TECHNICAL FIELD

The present disclosure relates generally to batteries and particularly to cycle life of Li-ion batteries.

### BACKGROUND

Lithium (Li)-ion batteries are key components in electric vehicles and electronic devices and “formation” of these batteries is a critical step/process during manufacturing. The formation process includes reducing electrolyte and forming a solid electrolyte interphase (SEI) layer at the negative electrode (NE). The SEI helps mitigate subsequent electrolyte reduction reactions during normal use of a Li-ion battery, and to ensure the robustness of the SEI and prevent Li plating on the NE during charging, formation is typically conducted at low current densities making it time consuming and costly.

The present disclosure addresses issues related to formation of Li-ion batteries, and other issues related to Li-ion batteries.

### SUMMARY

This section provides a general summary of the disclosure and is not a comprehensive disclosure of its full scope or all of its features.

In one form of the present disclosure, a method for extending battery cycle life of Li-ion battery includes executing a fast formation protocol on a Li-ion battery cell (cell) such that an induced Li loss shifts an electrode-specific utilization range with a lithiation level of the positive electrode decreased to be less than or equal 94%, thereby avoiding a kinetically limited region of the positive electrode. Also, the fast formation protocol of the Li-ion battery cell includes charging the cell to a maximum charging voltage of the cell in less than 2 hours during a first formation cycle.

In another form of the present disclosure, a method for extending battery cycle life of Li-ion battery includes executing a fast formation protocol on a Li-ion battery cell (cell) such that an induced Li loss shifts an electrode-specific utilization range with a lithiation level of the positive electrode decreased to be less than or equal 94%, thereby avoiding a kinetically limited region of the positive electrode. Also, the fast formation protocol of the Li-ion battery cell includes charging the cell to a maximum charging voltage of the cell in less than 1.5 hours during a first formation cycle.

In still another form of the present disclosure, a method for extending battery cycle life of Li-ion battery includes executing a fast formation protocol on a Li-ion battery cell (cell) such that an induced Li loss shifts an electrode-specific utilization range with a lithiation level of the positive electrode decreased to be less than or equal 94%, thereby avoiding a kinetically limited region of the positive electrode. Also, the fast formation protocol of the Li-ion battery cell includes charging the cell to a maximum charging voltage of the cell in less than 1 hour during a first formation cycle.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A is a graphical plot illustrating a Li-ion battery formation protocol according to the teachings of the present disclosure;

FIG. 1B is a graphical plot illustrating how CC1 and CC2 values sampled using Latin hypercube sampling;

FIG. 1C is a graphical plot showing the number of values tested for each formation parameter with the top row showing continuous variables and the top row showing discrete variables;

FIG. 2A is a graphical plot for the low-rate C/20 discharge capacity reference performance test (RPT) for every 100 cycles of all the formed Li-ion battery cells;

FIG. 2B is a graphical plot for the Hybrid Pulse Power Characterization (HPPC) reference performance test (RPT) for every 100 cycles of all the formed Li-ion battery cells;

FIG. 2C is a graphical plot for the high-rate 3C/4 discharge capacity for every 100 cycles of all the formed Li-ion battery cells;

FIG. 2D is a graphical plot for 62 formation protocols ranked by their mean total energy throughput on the vertical axis;

FIG. 3A is a graphical plot of cycle life as a function of formation time (24 h CV hold at 1.5 V excluded) for the 186 NMC532/AG cell dataset, with their distribution shown on each axis;

FIG. 3B is a matrix plot representing the feature importance of formation parameters (vertical axis) on performance metrics (horizontal axis);

FIG. 4A is a graphical plot of formation discharge capacity plotted as a function of formation first-cycle charge capacity;

FIG. 4B is a graphical plot of formation first-cycle charge capacity plotted as a function of the two formation charge currents;

FIG. 4C is an illustration of the electrode utilization range definition;

FIG. 4D is graphical correlation plot of cycle life versus PE SOCs at the bottom of discharge (3 V) immediately after formation;

FIG. 5A is a graphical plot of fitted differential voltage analysis of the electrode voltage for a slow-formed cell (CC1 and CC2=C/50) after formation and the vertical dashed lines representing when full cell hits the discharge cutoff voltage at 3 V (left vertical dotted line) and charge cutoff voltage at 4.4 V (right vertical dotted line);

FIG. 5B is a graphical plot of fitted differential voltage analysis of the electrode voltage for a fast-formed cell (CC1 and CC2≥1C) after formation and the vertical dashed lines representing when full cell hits the discharge cutoff voltage at 3 V (left vertical dotted line) and charge cutoff voltage at 4.4 V (right vertical dotted line);

FIG. 5C is a graphical plot of voltage versus capacity plot for C/20 and 3C/4 rates showing a comparison between a slow-formed cell and a fast-formed cell; and

FIG. 5D is a graphical correlation plot of full-cell resistance (10 s discharge resistance at 100% SOC) after 720 cycles versus PE utilization shift determined at bottom of discharge immediately after formation.

### DETAILED DESCRIPTION

The present disclosure provides methods for increasing battery cycle life of Li-ion batteries by up to 50%, for example up to 60% and/or up to 70%. In some variations, the methods disclosed herein increase battery cycle life of Li-ion batteries by more than 50% and less than or equal to 70%. And in at least one variation, the methods disclosed herein increase battery cycle life of Li-ion batteries by more than 60% and less than or equal to 70%. As used herein, the phrase “cycle life” refers to the number of complete charge and discharge cycles of a given Li-ion battery before the capacity of the Li-ion battery degrades below a predefined level, e.g., below 80% of the Li-ion battery's original capacity. The methods include using high formation charge currents that result in substantially shifting the electrode-specific utilization range, i.e., changing Li stoichiometry, by more than or equal to 3% at bottom of discharge and top of charge in both the negative electrode (NE) and the positive electrode (PE) after formation, which in turn results in avoiding a highly lithiated PE and decreasing the possibility of future Li plating on the NE.

As used herein, the term “formation” refers to the initial controlled charging/discharging cycles of a battery that are designed to form a solid electrolyte interphase (SEI) layer on the PE during charging and stabilize the electrochemistry of the battery. And as used herein, the phrase “electrode-specific utilization range” refers to Li stoichiometry of an electrode that top of charge and bottom of discharge during normal operation after formation. Stated differently, the electrode-specific utilization range defines which part of the electrode potential range is practically usable during cycling of a battery.

It should be understood that battery formation is an important early stage electrochemical conditioning process for a Li-ion battery that defines or establishes a Li-ion battery's long-term performance and safety, and has traditionally involved low currents over one to three cycles. It should also be understood that battery formation is one of the most time and energy intensive steps in the battery manufacturing process.

In some variations, fast formation protocols according to the teachings of the present disclosure result in an increase or inducement of Li loss compared to traditional formation protocols, and the induced Li loss shifts the electrode-specific utilization with the lithiation level of the PE decreased to be less than or equal to 94%, e.g., less than or equal to 92% or 90%, as determined via differential voltage analysis. It should be understood that for Li-ion batteries, after conventional formation, the PE and NE first cycle Coulombic efficiency are expected to match (i.e., be equal) such that the PE at full cell bottom of discharge can be highly lithiated (e.g., about 97%) as determined via differential voltage analysis. In contrast, in some variations the fast formation protocols according to the teachings of the present disclosure result in the PE at full cell bottom of discharge be lithiated at about 94% as determined via differential voltage analysis, thereby providing a 3% electrode utilization change or shift. As used herein, the phrase “differential voltage analysis” refers to the electrochemical diagnostic technique known to those skilled in the art that includes plotting the derivative of voltage with respect to capacity (dV/dQ) during battery charge or discharge, thereby providing information on phase transitions and redox reactions in electrode materials and enabling detection of degradation, lithium inventory loss (for Li batteries), and electrode imbalance over time. The differential voltage analysis used for the teachings of the present disclosure is outlined in the publications by Lee et al. titled “Electrode state of health estimation for lithium ion batteries considering half-cell potential change due to aging”, J. Electrochem. Soc. 167, 090531, and Wang et al. titled “Differential voltage analysis for battery manufacturing process control. Front. Energy Res. 11, 1087269. https://doi.org/10.3389/fenrg.2023.1087269, both of which are incorporated herein by reference in their entirety.

In some variations, the induced Li loss shifts the electrode-specific utilization between a NE and a PE by at least about 3% and less than about 7% compared to a conventionally formed battery and as determined via differential voltage analysis. In at least one variation, the induced Li loss decreases the electrode-specific utilization by at least 3%, for example, at least 5% and/or at least 7% as determined via differential voltage analysis. In some variations, the induced Li loss decreases the electrode-specific utilization by at least about 3% and less or equal to about 7% compared to the electrode-specific utilization of conventionally formed batteries and as determined via differential voltage analysis. And in some variations, the with fast formation protocols according to the teachings of the present disclosure, the PE lithiation is less than or equal to about 94% after formation as determined via differential voltage analysis. However, and counterintuitively, such a shift in the electrode-specific utilization and/or decrease in the PE lithiation level after formation results in an increase of the battery cycle life by up to 70%.

As used herein, the phrase “fast formation” or “fast formation protocol” refers to a formation protocol that charges a Li-ion battery cell (also referred to herein simply as “cell’) to a maximum fully charged voltage of the cell in less than 2 hours in the first formation cycle and after formation avoids a kinetically limited region of the PE potential, i.e., avoids a highly lithiated PE. In some variations, the fast formation protocol refers to a formation protocol that charges a Li-ion battery cell (also referred to herein simply as “cell’) to a maximum fully charged voltage of the cell in less than 1.5 hours in the first formation cycle and after formation avoids a kinetically limited region of the PE potential. In at least one variation, the fast formation protocol refers to a formation protocol that charges a Li-ion battery cell (also referred to herein simply as “cell’) to a maximum fully charged voltage of the cell in less than 1 hour in the first formation cycle and after formation avoids a kinetically limited region of the PE potential. And in some variations, the fast formation protocol refers to a formation protocol that charges a Li-ion battery cell (also referred to herein simply as “cell’) to a maximum fully charged voltage of the cell in more than or equal to 0.33 hours and less than or equal to 2 hours in the first formation cycle and after formation avoids a kinetically limited region of the PE potential. In addition, such kinetically limited regions of the PE potential are observed on a plot of voltage versus capacity for the PE, particularly where such a plot exhibits a sharp decrease in voltage.

In order to better describe the methods for increasing battery cycle life of Li-ion batteries according to the teachings of the present disclosure, but not limit the methods in any manner, discussion of battery formation, and examples of Li-ion battery formation and analysis, are described below.

Determining a relationship between formation parameters and battery cycle life is challenging due to the high dimensional parameter space of batteries and their operation, long feedback loops derived from cycle life testing, and difficulties in generalizing the results across different battery cell formats. For example, given that the SEI layer is formed on the NE electrochemically, parameters such as current, voltage, and temperature contribute to a final SEI composition and morphology. Therefore, iterating over the large parameter space of battery cycle life as a function of formation parameters requires a large number of experiments and long cycling time to properly evaluate the resultant cycling performance.

The present disclosure discloses the use of data-driven methods to navigate complex parameter spaces and identify improved conditions for operating devices such as batteries, and interpretable machine learning such as SHAP (SHapley Additive exPlanations23) analysis was used to reveal the impact of different parameters across the high-dimensional space noted above. Also, differential voltage analysis was used to monitor changes in PE and NE capacities (also referred to herein as “QPE” and “QNE”, respectively) and the cyclable Li inventory (QLi), thereby allowing detailed investigations at the electrode level. Accordingly, the present disclosure provides a data-driven workflow to design experiments and generate mechanistic insights that guide and accelerate formation of Li-ion batteries.

Experimentally, a 6-dimensional parameter space generated from a dataset of 186 single crystalline Li[Ni0.5Mn0.3Co0.2]O2 (SC-NMC532) PE-artificial graphite (AG) NE pouch cells formed across 62 different conditions was investigated. The SC-NMC532 PE has a press density of 3.3 grams per cubic centimeter (g/cm³), an active material ratio of 94.0 weight percent (wt. %), and a coating weight of 16 mg/cm². The AG NE had a press density of 1.5 gm/cm³, an active material ratio of 95.7 wt. %, and coating weight of 10 mg/cm². The NE to PE capacity ratio ranged from about 1.16 to about 1.2.

The electrolyte composition was 1M LiPF6 in ethylene carbonate (EC), ethyl methyl carbonate (EMC), dimethyl carbonate (DMC) (1:1:1 by volume) solvent with 2 wt % vinylene carbonate (VC) additive. It was observed that cycle life, ranging from 400 to 1300 cycles, depended strongly on the formation conditions and SHAP analysis was used to establish the relationship between formation conditions, electrode-specific utilization, cycle life and resistance growth. Because of the diverse formation conditions and full-cell format used, the role of formation in regulating SEI properties and alignment of electrode voltage curves impact battery cycle life was determined. Particularly, performance enhancements were observed for high formation charge currents that shift electrode-specific utilization range (i.e., Li stoichiometry at bottom of discharge and top of charge in both electrodes). High formation temperature were also studied and positively impacted battery cycle life.

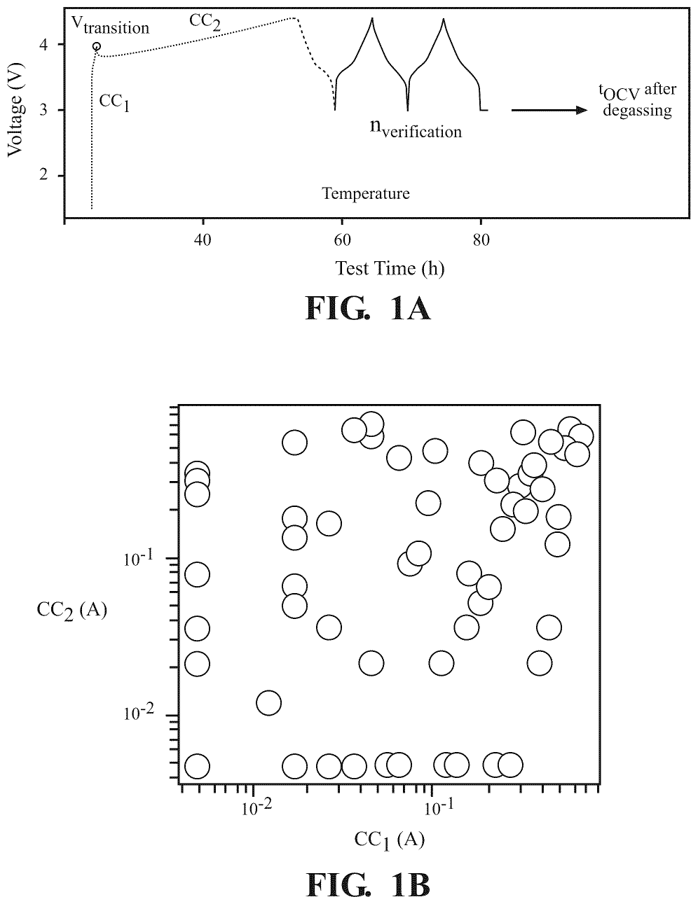

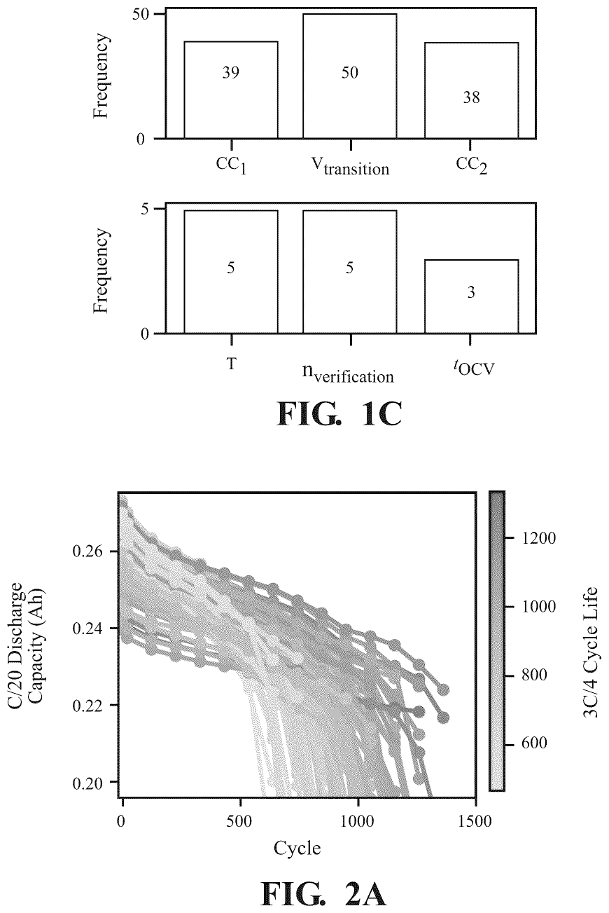

To understand the voltage-dependent formation of SEI, a two-step charge formation template was designed and used. Using the formation template, a formation temperature (T), two-step formation charge currents (CC1 and CC2), a transition voltage (Vₜᵣₐₙₛᵢₜᵢₒₙ) between CC1 and CC2, a number of verification cycles after the first charge (n_{verification}), and a rest time after formation (t_{OCV}) were systematically changed. FIG. 1A illustrates an example formation protocol.

To generate the 62 formation conditions noted above, Latin hypercube sampling was used to ensure sampled values were distributed over a wide parameter space and correlation between parameters was minimized (e.g., see FIG. 1B). Each formation condition was tested with three replicates to ensure the reliability of the results and FIG. 1C shows the number of values tested for each formation parameter with the top row showing continuous variables and the top row showing discrete variables.

At a specified formation temperature, cells were first charged at C/5 to 1.5 volts (V) and held for 24 hours (h) to avoid copper (Cu) current collector corrosion and enhance electrolyte wetting. It should be understood that ‘1 C’ is the nominal current needed to discharge the battery in 1 hour and thus C/5 is the nominal current needed to discharge the battery in 5 hours. After the two-step charge of CC1 and CC2, a 1 hour constant voltage (CV) hold was applied at top of charge (4.4 V, also referred to herein as “maximum charging voltage”), followed by a C/5 discharge to 3 V. After the first formation cycle, n_{verification} additional ±C/5 cycles were performed between 3 V and 4.4 V without CV hold or rest periods (see FIG. 1A), and then cells were held at 3 V for 1 hour before being degassed and resealed in an argon (Ar) glove box.

After undergoing different formation procedures, cells were aged identically in a temperature-controlled chamber set at 30° C. The aging cycle consisted of a 1 C charge to 4.4 V with a CV hold to C/20 and then a 3C/4 discharge to 3 V. To probe the low-rate capacity and internal resistances of the cells, diagnostic tests including reference performance tests (RPTs) consisting of C/20 and C/5 discharge cycles and hybrid pulse power characterization (HPPC) were performed. The C/20 discharge data was used for differential voltage analysis to estimate electrode-specific capacities and states of charge (SOCs).

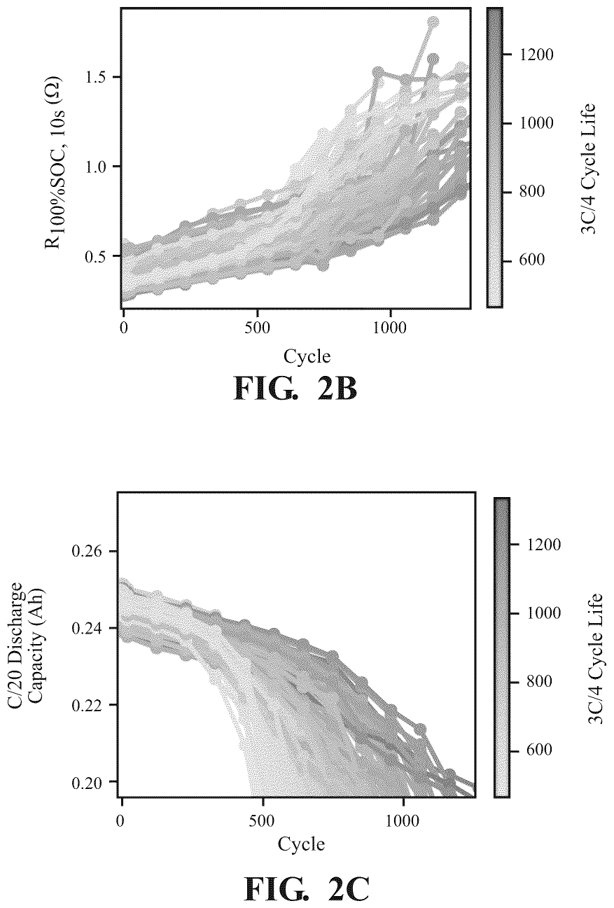

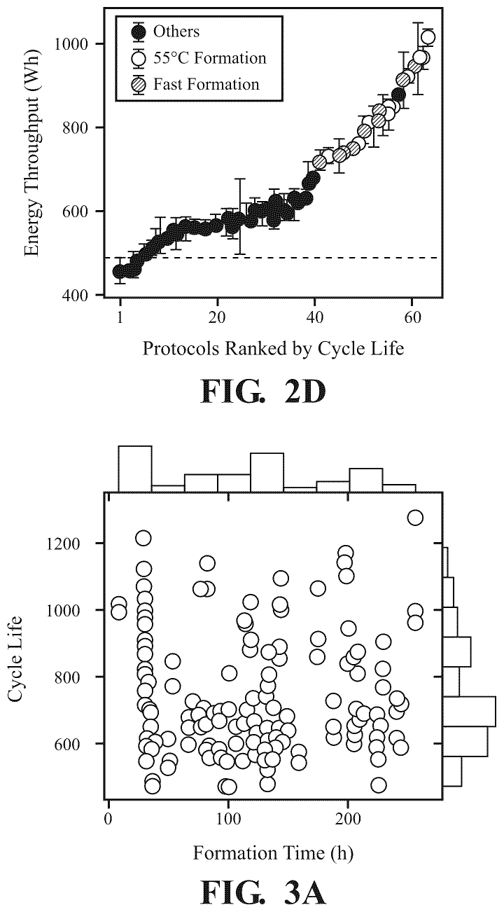

Regarding charge/discharge cycling of the cells, and with reference to FIGS. 2A-2C, the capacity and resistance degradation after formation were first examined. FIGS. 2A and 2B show C/20 discharge capacity and 3C/4 discharge capacity, respectively, as a function of number of charge/discharge cycles for all cells, and FIG. 2C shows the HPPC 10 second discharge resistance as a function of charge/discharge cycles. As observed from FIGS. 2A-2B, the effect formation parameters have on cell aging performance is substantial. The variability of the initial RPT C/20 discharge capacity within the same protocol was less than ±2%, thereby illustrating that the variation in the initial capacity of a cell is induced by formation condition. Cycle life was defined as when the 3C/4 aging cycle discharge capacity of a cell reached 80% of its initial value.

Referring to FIG. 2D, the repeatability of the cycling results was demonstrated by plotting the total energy throughput of three replicates for each formation protocol. A baseline formation protocol was defined as a C/20 charge and discharge cycle at 40° C., which is commonly employed for similar cells in known battery formation protocols. It was observed that the top-performing formation protocol resulted in approximately a 110% increase in the total energy throughput relative to the baseline formation protocol (shown by the dotted line in FIG. 2D). Furthermore, short-lived cells (i.e., cycle life less than 610 cycles, indicated in light gray) displayed low resistance but underwent a sharp resistance increase after about 490 cycles, thereby triggering a rapid capacity decline at a similar cycle count as illustrated in FIGS. 2A-2B. Accordingly, the sharp increase of resistance in later cycles suggests that early resistance measurements may not be a good predictor of the final cycle life when evaluating various formation protocols and interpretable machine learning was used to understand how low formation protocol parameters influenced degradation metrics.

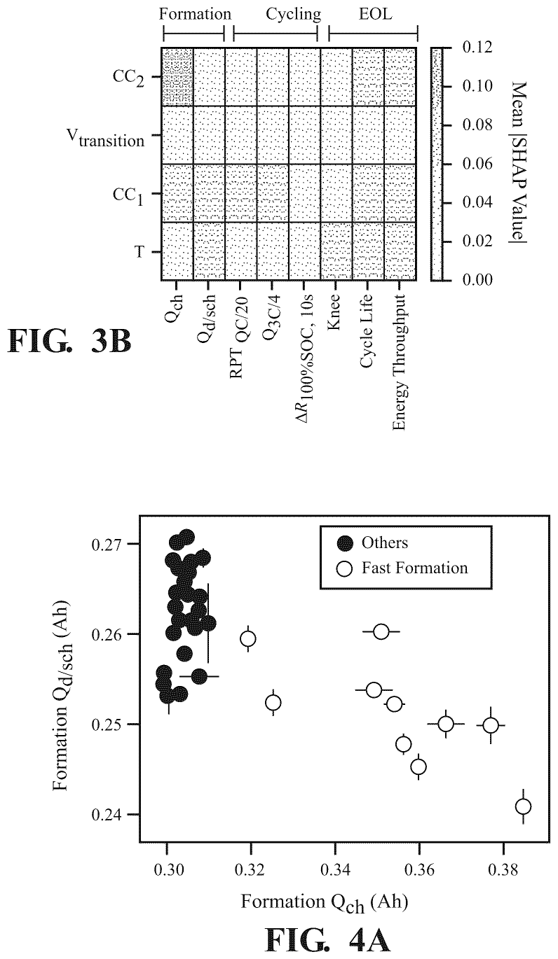

Referring to FIG. 3A, cycle life was plotted as a function of formation time. Formation time (excluding the 24 h CV hold at 1.5 V) reflected various formation currents, number of cycles and the rest time (after degassing and before cycling aging) applied to the cell, and as observed from FIG. 3A, the weak correlation between cycle life and formation time suggested that formation time can be shortened without compromising battery performance. In addition, a random forest model together with SHAP analysis were used to quantify the impact of formation cycling parameters on battery performance with the first charge formation parameters used as inputs to construct a prediction model for each performance metric. The performance metrics were chosen from different stages of operation: during formation (formation first-cycle charge capacity and last cycle discharge capacity); after 120 aging cycles (RPT C/20 discharge capacity, 3C/4 aging discharge capacity and HPPC resistance growth); and at the end of life (total energy throughput, cycle life and knee, when capacity suddenly drops). After training the random forest model, SHAP analysis was used to quantify the importance of a given feature/parameter.

With reference to FIG. 3B, it was observed that the key parameters influencing battery performance were formation currents and temperature with a darker color on the plot indicating higher positive impact on battery cycle life and Vₜᵣₐₙₛᵢₜᵢₒₙ, n_{verification} and t_{OCV} barely impacting the aging metrics. Also, and with reference back to FIG. 2D, high-performing formation protocols utilized high temperature (55° C. formation temperature) and high formation current rates (CC1 and CC2≥1 C), cells subjected to high formation current rates referred to herein and labeled in the drawings “fast-formed” or “fast formation”. It should be understood that the cycle life performance of the fast-formed cells is an unexpected result given that prior studies and traditional formation protocols has shown that fast formation induces Li plating and thus negatively impacts battery cycle life, and that high formation temperatures can damage the electrolyte. However, it is observed from FIG. 3B that formation first-cycle charge capacity (Qch) is strongly impacted by CC1 and CC2, but it is not impacted by formation temperature. Accordingly, the improved cycle life from high formation currents and temperature originates from different mechanisms as discussed below.

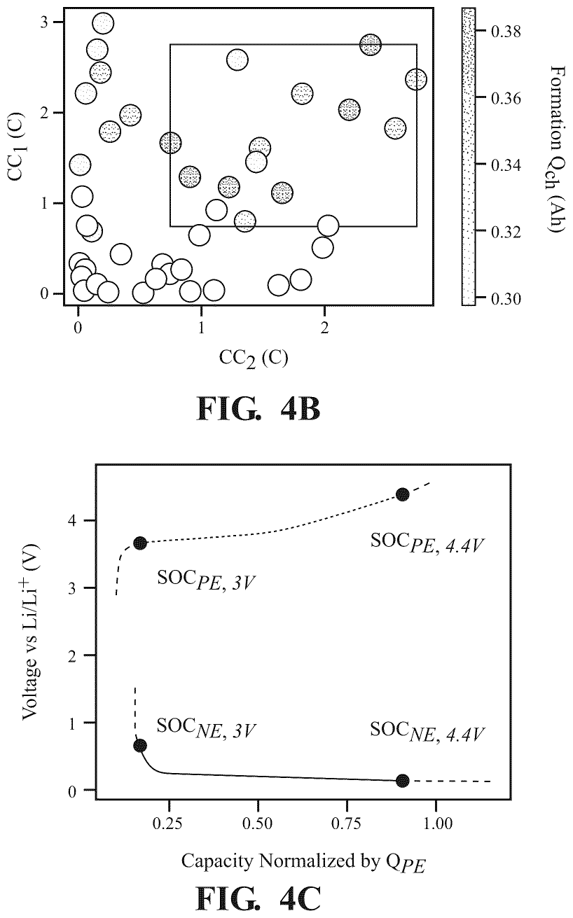

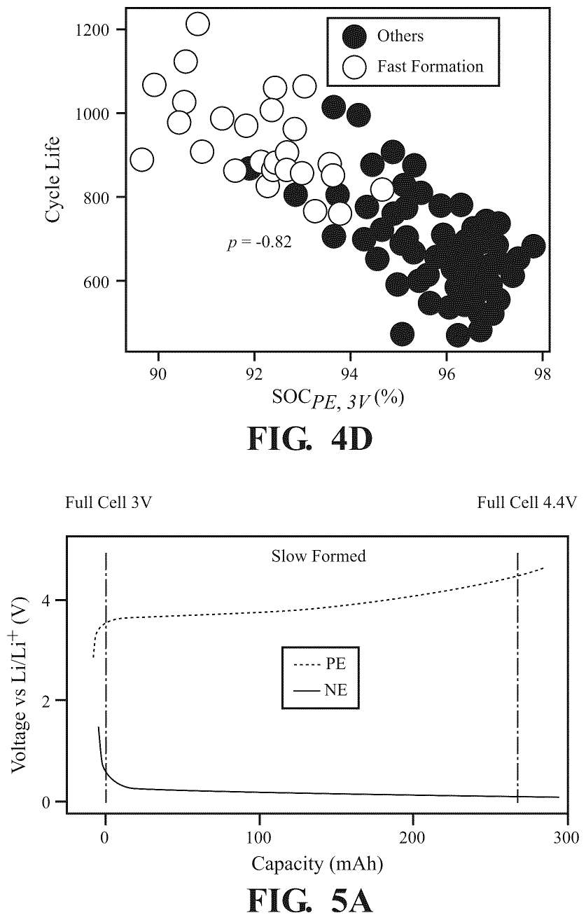

Fast-formed cells experience significant Li inventory loss during formation with insights into how formation currents affect cycle life examined by how such currents affect first-cycle charge capacity formation Qch. Referring to FIG. 4A, cells formed with high CC1 and CC2 (i.e., ≥1C) lead to more charge capacity with an increase in Q_{ch} of more than 20% observed for some of the fast formed cells. And as observed from FIG. 4B, if only one of the two currents is high, the increased capacity does not manifest. FIG. 4A also illustrates that the increase in initial charge capacity for fast-formed cells is accompanied by up to a 7% decrease in the C/5 formation discharge capacity, thereby indicating significant Li inventory loss occurs. The large charge capacity for fast-formed cells during the 1 hour CV hold potentially originates from Li plating reactions and plated Li was detected in the dissected cells after CV hold. Traditionally, greater Li inventory loss during formation is associated with a thicker SEI and/or Li plating, increased resistance, and decreased discharge capacity, which negatively affect capacity and energy throughput during cycling. However, the fast-formed cells according to the teachings of the present disclosure did not experience large resistance increases and did exhibit a cycle life approximately 50% longer on average than cells formed using the baseline protocol.

A lower post-formation Li inventory resulted in a shift in electrode-specific utilization as determined using differential voltage analysis. Particularly, differential voltage analysis was used to estimate the positive electrode SOCs at bottom of discharge for fast-formed cells using the full-cell RPT C/20 discharge voltage curves after formation. And as shown in FIG. 4C, the utilization range of an electrode is determined by its SOC at full cell top of charge (4.4 V) and bottom of discharge (3 V). The dots in FIG. 4C represent the positive electrode (PE, cathode) and negative electrode (NE, anode) SOCs when the full cell reaches the charge and discharge cutoff voltage at 3 V and 4.4 V, respectively. Also, and due to loss of Li inventory for fast formed cells and cutoff voltages, only part of the theoretical voltage range for an electrode indicated by the dotted line in the graphical plot was accessible with unused electrode voltage ranges beyond the full cell's voltage range of 3 V to 4.4 V. It was observed that in some variations the shift in electrode-specific utilization resulted in an electrode-specific utilization that was at least 3% for both electrodes compared to conventionally formed batteries as determined via differential voltage analysis, and in at least one variation it was observed the shift in electrode-specific utilization resulted in an electrode-specific utilization that was at least 6% compared to conventionally formed batteries as determined via differential voltage analysis. Stated differently, it should be understood that for conventionally formed batteries, PE SOC at full cell bottom discharge is around 97% as determined via differential voltage analysis, but for the fast-formed cells according to the teachings of the present disclosure the PE SOC at full cell bottom discharge was between about 90% and about 94%, as determined via differential voltage analysis, thereby providing or resulting in a change or shift between about 3% and about 7%.

Referring to FIG. 4D, a plot of cycle life as a function of SOC_{PE,3V} immediately after formation illustrates that PE SOCs of fast-formed cells (dark dots) at the bottom of discharge are up to 8% lower compared to the non fast-formed cells (light dots). Notably, there is a negative correlation between PE SOC and cycle life. As a separate validation, full cells were disassembled at different voltages to harvest electrodes and make coin half cells with a Li metal counter to compare the individual electrode voltage readings for fast and slow-formed cells, where slow is defined as CC1 and CC2≤C/5. And higher voltage readings vs Li/Li+ were obtained for cathodes of fast-formed full cells in the discharged state, confirming a lower Li stoichiometry. Accordingly, fast formation decreased PE utilization in the deep lithiation region.

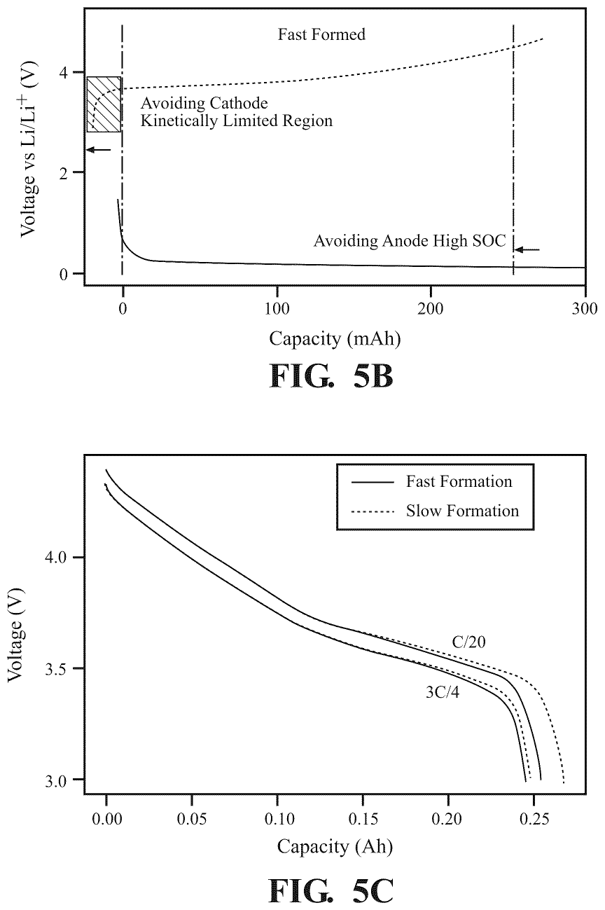

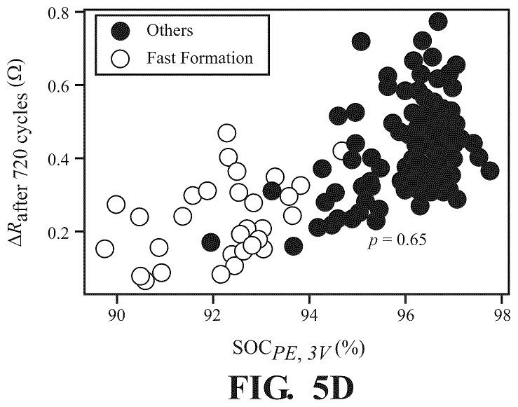

Not being bound by theory, neither electrode is 100% efficient during the first cycle, but the mechanistic principles behind the inefficiency are different. In the PE, Li cannot be completely re-intercalated on discharge, a phenomenon attributed to the sluggish reaction kinetics at high lithiation states. And in the NE, Li cannot be completely extracted due to the side reactions such as SEI formation or Li plating, which occur during charge. However, and even in the absence of side reactions at the NE, a decrease in full cell discharge capacity would be expected because not all of the Li reinserts. From half cell measurements, the first-cycle Coulombic efficiency (CE) of the NMC532 PE (90.5%) was slightly lower than that of artificial graphite NE (92.5%), indicating the intrinsic reversibility of intercalation reactions in NMC is lower than that of graphite. To efficiently use the Li in the PE and to prevent overlithiation of the graphite NE, the PE and NE voltage curves should ideally align when the cell is fully discharged after formation, as shown in FIG. 5A. It is proposed that the cathode PE is not impacted by changes to the formation charge current magnitude since PE inefficiencies only occur on discharge. However, changes to the formation charge current can significantly vary the anode NE depending on the amount of parasitic side reactions that occur. High charge currents lead to more irreversible side reactions on the NE (e.g. Li plating), causing the full cell discharge capacity to be significantly limited by the Li inventory, as illustrated in FIG. 5B. Slow and fast-formed cells may have similar 3C/4 discharge capacities after formation (0.246±0.001 vs 0.244±0.002), but their electrode-specific utilization range, the potential range where the PE and NE are cycled after formation, differ substantially.

The shifted electrode-specific utilization has two primary effects. First, and for the PE, the kinetically limited region at high lithiation states is avoided. And given that layered oxide-based PEs dominate the full cell resistance at high Li stoichiometry, improved kinetics are observed. Second, and despite minimal change in NE voltage at full cell top of charge, the NE reaches a lower Li stoichiometry, thereby decreasing the probability of future Li plating and continued Li inventory loss. Also, the utilization range shift only occurs when electrodes are in a highly lithiated state and fast formation shifts the utilization range for both electrodes in a favorable direction.

Despite the decreased Li inventory, fast and slow-formed cells have similar cycle aging discharge capacities at 3C/4 (on average less than 1% difference at beginning of life), leading to an overall improvement in the total charge/energy throughput. When cells are discharged slowly (C/20), the PE of a slow-formed cell accesses the kinetically limited region at high lithiation, yielding higher discharge capacity as shown in FIG. 5C. However, at higher discharge rates (3C/4), both fast and slow-formed cells experience higher overpotential. Due to this increased cell overpotential, the kinetically limited region is not accessed even for the slow formed cells, resulting in minimal difference in 3C/4 discharge capacity between fast and slow-formed cells.

The electrode-specific utilization shift during fast formation is achieved by more side reactions, particularly Li plating, and adjusting cell design parameters such as negative-to-positive electrode capacity ratio (N/P) does not have the same effect. The first-cycle charge capacity during formation decreases with temperature for fast-formed cells, while it increases for slow-formed cells. This inverse relation is consistent with Li plating as the majority of side reactions since temperature improves intercalation kinetics and transport properties in graphite and make Li plating less likely. Conversely, SEI reactions, if dominant, increase rather than decrease with temperature. The substantial Li plating for fast-formed cells was further confirmed by visual inspection of electrodes after formation charge.

Lithium inventory loss also occurs gradually during aging cycling. However during aging, gradual Li inventory loss is accompanied by resistance growth and other forms of degradation which supersede the benefits. However under diverse formation conditions, Li loss during formation had no correlation with cell resistance immediately after formation as illustrated in FIG. 5D. The considerable utilization shift during formation enables examination of its impact free of other degradation modes. And as shown by FIG. 5D, the shifted utilization leads to less resistance growth in subsequent cycling.

While described as methods and illustrated with flowcharts, it should be understood that the present disclosure provides for systems that execute the methods described herein. For example, a system disclosed herein can include a processor, a memory communicably coupled to the processor and storing machine-readable instructions that, when executed by the processor, cause the processor to perform the methods and/or method steps disclosed herein, among others.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

As used herein, the term “about” when used in reference to a numerical value refers to values that are within +/−10% of the numerical value.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A method for increasing battery cycle life of Li-ion battery, the method comprising:
executing a fast formation protocol on a Li-ion battery cell (cell) such that an induced Li loss shifts battery electrode-specific utilization range after formation with a lithiation level of a positive electrode of the cell decreases to be less than or equal 94% as determined via differential voltage analysis, the fast formation protocol of the cell comprising charging the cell to a maximum charging voltage of the cell in less than 2 hours during a first formation cycle and avoiding a kinetically limited region of the positive electrode.

2. The method according to claim 1, wherein the lithiation level of the positive electrode is decreased to be less than or equal 92% as determined via differential voltage analysis.

3. The method according to claim 2, wherein the lithiation level of the positive electrode is decreased to be less than or equal 90% as determined via differential voltage analysis.

4. The method according to claim 1, wherein the lithiation level of the positive electrode is decreased to be less than or equal 94% and greater than or equal to 90% as determined via differential voltage analysis.

5. The method according to claim 1, wherein the fast formation protocol of the cell comprises charging the cell to the maximum charging voltage of the cell in less than 1.5 hours during the first formation cycle and avoiding the kinetically limited region of the positive electrode.

6. The method according to claim 1, wherein the fast formation protocol of the cell comprises charging the cell to the maximum charging voltage of the cell in less than 1 hour during the first formation cycle and avoiding the kinetically limited region of the positive electrode.

7. The method according to claim 1, wherein the fast formation protocol of the cell comprises charging the cell to the maximum charging voltage of the cell in less than 0.5 hours during the first formation cycle and avoiding the kinetically limited region of the positive electrode.

8. The method according to claim 1, wherein the lithiation level of the positive electrode is decreased to be less than or equal 94% and greater than or equal to 90% as determined via differential voltage analysis, and the fast formation protocol of the cell comprises charging the cell to the maximum charging voltage of the cell in less than 1 hour during the first formation cycle and avoiding the kinetically limited region of the positive electrode.

9. A method for increasing battery cycle life of Li-ion battery, the method comprising:
executing a fast formation protocol on a Li-ion battery cell (cell) such that an induced Li loss shifts an electrode-specific utilization range with a lithiation level of a positive electrode of the cell decreases to be less than or equal 94% as determined via differential voltage analysis, the fast formation protocol of the cell comprising charging the cell to a maximum charging voltage of the cell in less than 1.5 hours during a first formation cycle and avoiding a kinetically limited region of the positive electrode.

10. The method according to claim 9, wherein the shift of the electrode-specific utilization range after formation is a decrease in the positive electrode lithiation level at full bottom discharge greater than or equal to 3% and a decrease in a negative electrode lithiation level of the cell at full cell top of charge greater than or equal to 3%, as determined via differential voltage analysis.

11. The method according to claim 10, wherein the shift of the electrode-specific utilization range after formation is a decrease in the positive electrode lithiation level at full bottom discharge greater than or equal to 5% and a decrease in the negative electrode lithiation level at full cell top of charge greater than or equal to 5%, as determined via differential voltage analysis.

12. The method according to claim 11, wherein the shift of the electrode-specific utilization range after formation is a decrease in the positive electrode lithiation level at full bottom discharge is between about 3% and about 7% and a decrease in the negative electrode lithiation level at full cell top of charge is between about 3% and about 7%, as determined via differential voltage analysis.

13. The method according to claim 9, wherein the fast formation protocol of the cell comprises charging the cell to the maximum charging voltage of the cell in less than 1 hour during the first formation cycle and avoiding the kinetically limited region of the positive electrode.

14. The method according to claim 13, wherein the shift of the electrode-specific utilization range after formation is a decrease in the positive electrode lithiation level at full bottom discharge is between about 3% and about 7% and a decrease in a negative electrode lithiation level of the cell at full cell top of charge is between about 3% and about 7%, as determined via differential voltage analysis.

15. The method according to claim 14, wherein the fast formation protocol of the cell comprises charging the cell to the maximum charging voltage of the cell in less than 0.5 hours during the first formation cycle and avoiding the kinetically limited region of the positive electrode.

16. A method for increasing battery cycle life of Li-ion battery, the method comprising:
executing a fast formation protocol on a Li-ion battery cell (cell) such that an induced Li loss shifts an electrode-specific utilization range with a lithiation level of a positive electrode of the cell decreases to be less than or equal 94% as determined via differential voltage analysis, the fast formation protocol of the cell comprising charging the cell to a maximum charging voltage of the cell in less than 1.5 hours during a first formation cycle and avoiding a kinetically limited region of the positive electrode.

17. The method according to claim 16, wherein the shift of the electrode-specific utilization range after formation is a decrease in the positive electrode lithiation level at full bottom discharge greater than or equal to 3% and a decrease in a negative electrode lithiation level of the cell at full cell top of charge greater than or equal to 3%, as determined via differential voltage analysis.

18. The method according to claim 17, wherein the shift of the electrode-specific utilization range after formation is a decrease in the positive electrode lithiation level at full bottom discharge greater than or equal to 5% and a decrease in the negative electrode lithiation level at full cell top of charge greater than or equal to 5%, as determined via differential voltage analysis.

19. The method according to claim 18, wherein the shift of the electrode-specific utilization range after formation is a decrease in the positive electrode lithiation level at full bottom discharge is between about 3% and about 7% and a decrease in the negative electrode lithiation level at full cell top of charge is between about 3% and about 7%, as determined via differential voltage analysis.

20. The method according to claim 16, wherein the fast formation protocol of the cell comprises charging the cell to the maximum charging voltage of the cell in less than 1 hour during the first formation cycle and avoiding the kinetically limited region of the positive electrode.
